(19) United States
(12) Patent Application Publication
(10) Pub. No.: US 2006/0262112 A1
(43) Pub. Date: Nov. 23, 2006

(54) System and method for three-dimensional shape generation from partial and incomplete views, and interactive design system using same

(75) Inventor: Kenji Shimada, Pittsburgh, PA (US)

Correspondence Address: KIRKPATRICK & LOCKHART NICHOLSON GRAHAM LLP, 535 SMITHFIELD STREET, PITTSBURGH, PA, 15222, US

(73) Assignee: Carnegie Mellon University

(21) Appl. No.: 11/135,528

(22) Filed: May 23, 2005

(51) Int. Cl. G06T 15/00

(52) U.S. Cl. 345/419

(57) ABSTRACT

Systems and methods for automatically generating a three-dimensional model of an object based on an input set of images of the object that may only have partial or incomplete information about the object's shape are disclosed. The technique may assumes a template geometry, which represents a similar shape to the target object, and applies free-form deformation iteratively until the deformed shape matches a given set of partial views of the object. A non-linear numerical optimization technique is used to find the optimal deformation of the template geometry to achieve a good match. Also disclosed is an interactive design system that may be used to design an object whereby design modifications are applied interactively by a user to an existing design geometry to generate a new design geometry. The new design geometry is generated using extended free form deformation and optimization to deform the existing design of the object to match the new design.

### BACKGROUND OF THE INVENTION

1. Field of the Invention

The present invention is generally related to techniques for creating a three-dimensional model of an object from a set of images of the object.

2. Background

Many approaches have been developed for reconstructing three-dimensional models from a set of computed tomography (CT) images. These approaches can generally be classified into two categories: without deformable objects and with deformable objects.

For approaches without deformable objects, the general approaches to three-dimensional reconstruction may again be classified into two groups: (i) surface oriented model and (ii) volume oriented models. In surface-oriented models, three fundamental problems are experienced in building a surface between contours in adjacent cross-sections: the correspondence problem, the tilting problem, and the branching problem. In volume reconstruction, the voxel technique is often employed. A voxel is the spatial equivalent of a pixel. Since images are arranged on a rectangular 2D grid, it is quite natural to extend them to volume elements. There are two ways to display such a set of parallelepiped. In one way, a surface can be fit on it and the object can be rendered with conventional surface-rendering algorithms. In the other way, the surface normals are deduced from the voxel data.

Although the approaches are popular in three-dimensional reconstruction, they have several disadvantages. For example, many surface-oriented reconstruction approaches lead to topologically or geometrically invalid shapes, such as holes or overlapping surfaces in realistic scenes. Also, because of difficulties automating the branching problem, user interaction is often required when complex contours exist. Volume reconstruction has the disadvantage of being computationally intensive due to the large volume of data that has to be manipulated. Also, if cross-section distances from CT data are large compared to pixel distances, an interpolation step is necessary to avoid discontinuous edges.

Reconstruction with deformable objects is useful in obtaining a precise representation of human organs with a better robustness in the presence of noise in medical imaging because the geometrical structure of an object is often known before the data is acquired. Three-dimensional reconstruction approaches that use deformable objects can substantially improve the accuracy of reconstructions obtained from limited data when good geometrical information is employed in the model.

In some deformable object reconstruction approaches, the point vector that lists the components of each of the vertices of a triangulated surface is directly moved. This approach, however, is inefficient where the models involve many thousands of parameters. Other approaches associate a deformable model, such as superellopsoids or triangular meshes, with a global volumetric deformation, namely free-form deformation (FFD). The reason is that FFDs cannot only deform all kinds of surface primitives, including planes, implicit surfaces, quadrics, superquadrics, but also define the deformation of the object by a small number of points. The deformation technique, however, handles only a specific type of deformation—that defined by a parallelepiped lattice. That means that the parallelepiped shape of the FFD lattice prohibits arbitrarily shaped deformation. Besides, when FFD is used to reconstruct three-dimensional geometry, there are many control points, making the reconstruction problem more complex and requiring additional information to find the solution.

The use of FFD to reconstruct three-dimensional models of bones using two or more X-ray images of the bones have been proposed, such as in U.S. Pat. No. 6,701,174, for use in computer assisted orthopedic surgery planner software. Such systems, however, were limited to square (parallelepiped) grids.

### SUMMARY

In one general aspect, the present invention is directed to systems and methods for automatically generating a three-dimensional model of an object based on an input set of images of the object that may only have partial or incomplete information about the object's shape. The technique may assumes a template geometry, which represents a similar shape to the target object, and applies free-form deformation iteratively until the deformed shape matches a given set of partial views of the object. A non-linear numerical optimization technique is used to find the optimal deformation of the template geometry to achieve a good match.

Given a template 3D shape and partial and incomplete views of a target object, the present invention, according to various embodiments, applies a 3D free-form deformation until the deformed 3D shape gives similar views to the given partial and incomplete views. The partial and incomplete views can be projection images or cross section images (such as CT scans of the object). Partial and incomplete views can be taken from two or three orthogonal directions, or multiple non-orthogonal directions.

A deformation can be achieved by a rectangular control grid or a non-rectangular control grid, such as a triangular control grid or a hexagonal control grid. In addition, either a polynomial interpolation function (such as a cubic Bezier curve) or a non-polynomial function can be used for deforming the 3D object. A non-linear numerical optimization technique may then be applied to find an optimal combination of free-form deformation parameters that generate a deformed 3D shape that matches given partial and incomplete views.

In another general aspect, the present invention is directed to systems and methods for interactively designing an object, such as an automobile, etc. According to various embodiments, the system includes a graphical user interface, such as a tablet PC, that includes a user input device for inputting a design modification to an existing design of the object displayed for the user on the graphical user interface. The system also includes a three-dimensional shape reconstruction system in communication with the graphical user interface for generating a three-dimensional model of the object based on the design modification input by the user. The design modification may include a first input from the user to indicate the portion of the existing design to be modified and a second input to indicate the desired geometry of the portion of the existing design for the new or modified design. The three-dimensional shape reconstruction system may include a deformation module and an optimization module. As mentioned above, the deformation module may apply an extended free form deformation on a template geometry for the existing design, and the optimization module may determine a combination of free-form deformation parameters corresponding to a deformed three-dimensional shape that optimally matches the design modification.

### DESCRIPTION OF THE FIGURES

Various embodiments of the present invention are described herein by way of example in conjunction with the following figures, wherein:

FIG. 1 is a diagram of a three-dimensional shape reconstruction system (3DSRS) according to various embodiments of the present invention;

FIGS. 2-16 help illustrate the process of using the 3DSRS to generate a three dimensional model of an abdominal aortic aneurysm using CT scans of the abdominal aortic aneurysm according to various embodiments of the present invention;

FIGS. 17-19 help illustrate the process of using the 3DSRS to generate a three-dimensional model of a bone using X-ray images of the bone according to various embodiments of the present invention;

FIGS. 20-22 help illustrate the process of using the 3DSRS to generate a three-dimensional model of a tooth using X-ray images of the tooth according to various embodiments of the present invention;

FIG. 23 is a diagram of a design system including the 3DSRS according to various embodiments of the present invention; and

FIG. 24-31 help illustrate the process of using the design system to design an object (in this case an automobile) according to various embodiments of the present invention.

### DESCRIPTION OF THE INVENTION

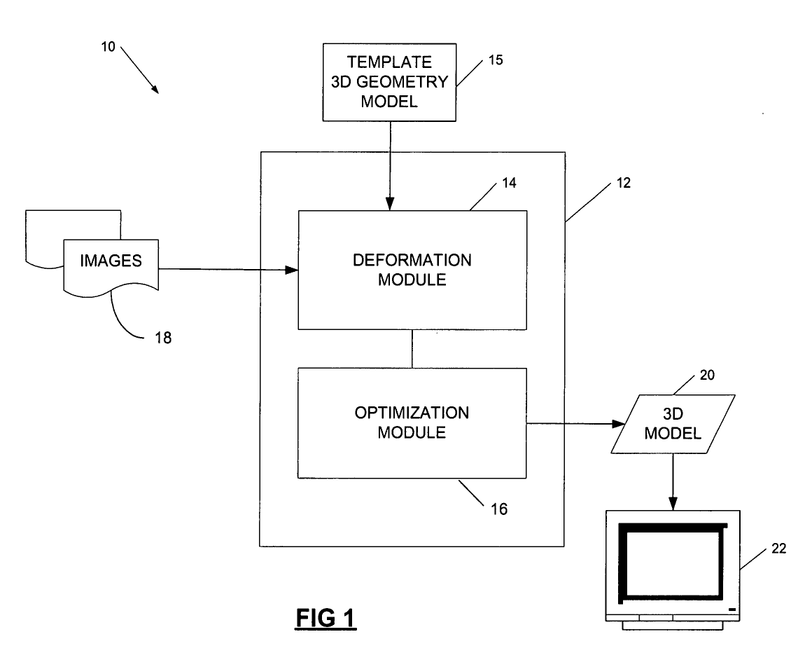

FIG. 1 is a diagram of a three-dimensional shape reconstruction system (3DSRS) 10 according to various embodiments of the present invention. The 3DSRS 10, as explained in more detail below, may take as input partial or incomplete information of an object's shape (such as the images 18) and based thereon, as well as a template 3D geometry model 15 for the object, generate a three-dimensional (3D) geometric model of the object. According to various embodiments, the template geometry model 15 for the object may represent a similar shape to the target object. The template geometry model 15 may include a number of control grids that may be, for example, rectangular or non-rectangular, such as triangular or hexagonal. The 3DSRS 10 may then apply a free-form deformation (FFD) or extended free-form deformation (EFFD) iteratively on the template geometry model 15 until the deformed shape matches the given set of partial or incomplete views 18 of the object. The 3DSRS 10 may employ an optimization technique to find the optimal deformation of the template geometry to achieve a good, or optimal, match for the given set of views of the object.

As shown in the embodiment of FIG. 1, the 3DSRS 10 may include a computer system 12. The computer system 12 may be implemented as one or a number of networked computing devices, such as PCs, laptops, servers, workstations, etc. The computer system 12 may include a deformation module 14 and an optimization module 16. The computer system 12 may receive as inputs a set of views 18 of the target object for which the 3D shape reconstruction model is to be generated. The set of views 18 may contain only partial or incomplete information about the shape of the target object. The set of views 18 may include, for example, x-ray or CT views of the target shape. The input images 18 may be projection views of the target object, such as for x-ray images, or cross-sectional views of the target object, such as for CT images. For projection views, as described in more detail below, the partial and incomplete views can be from two orthogonal directions, or they can be from arbitrary directions.

The deformation module 14, using an appropriate template geometry model 15 for the geometry of the target object, may iteratively apply FFD or EFFD on the template geometry until the deformed 3D shape gives similar views to the input images 18. According to various embodiments, as discussed above, the deformation can use a rectangular control grid or a non-rectangular grid, such as a triangular control grid or a hexagonal control grid. Also, the deformation module 14, according to various embodiments, may use a polynomial interpolation function or a non-polynomial interpolation function for deforming the object. Each type of free-form deformation may, therefore, be represented by a type of control grid, interpolation function, and deformation parameters.

The optimization module 16, as described in more detail below, may use a linear or non-linear optimization algorithm to find the optimal deformation of the template geometry. That is, according to various embodiments, the optimization module 16 may determine an optimal combination of free-form deformation parameters that generate a deformed 3D shape that matches the given input views 18. These parameters, corresponding to the generated 3D shape reconstruction model 20 for the object, may then be used to create model views of the object that may be displayed for a user of the system 10 on a monitor 22.

The deformation module 14 and the optimization module 16 may be implemented as software code to be executed by a processor (not shown) of the computer system 10 using any suitable computer instruction type such as, for example, Java, C, C++, Visual Basic, Pascal, Fortran, SQL, etc., using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM or DVD-ROM.

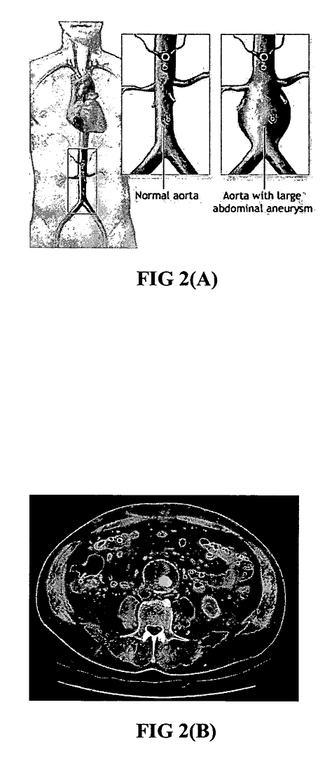

In one embodiment, the 3DSRS 10 can be used to generate a 3D model of an abdominal aortic aneurysm (AAA). As shown in FIG. 2(a), an AAA is condition in which turbulent blood flow in the abdominal aorta begins to form clots and causes subsequent ballooning of the vessel at a steady rate. For medical diagnosis purposes, a complete 3D geometry can be constructed by specifying the contour of an AAA in each of hundreds of cross sectional images from CT scans, such as the one shown in FIG. 2(b). For such an embodiment, the three-dimensional template geometry of an abdominal aorta, such as shown in FIG. 3, is used as a based model to reconstruct the specific aorta geometry. The template may be represented as a shell of polygonal mesh, consisting of a set of vertices and a set of faces. It is preferable that there are no gaps or overlaps between faces. Moreover, the resolution of the template should be fine enough to that its shape features will still be visible after the template is deformed. For example, the template polygonal model may be on the order of 4,400 vertices and 8,800 triangular meshes.

Given the template geometry, the deformation module 14, according to various embodiments, may find the deformation that has to be applied to minimize the area between the contours in the input images 18 (e.g., CT scans) and planar cross contours of the template. Extended free-form deformation (EFFD) can be used for this process. The basic premise of EFFD is that, instead of deforming the object directly, the object is embedded in a geometric space (corresponding to the geometry of the control grids that are used) that is deformed. This technique defines a free-form deformation of space by specifying a trivariate Bezier solid, which acts on a corresponding region of space. One physical and intuitive analogy of FFD is that a flexible object is “molded” in a clear plastic block and whole block is deformed by stretching, twisting, squeezing, etc. of the block. As the block is deformed, an object trapped inside the block is also deformed accordingly.

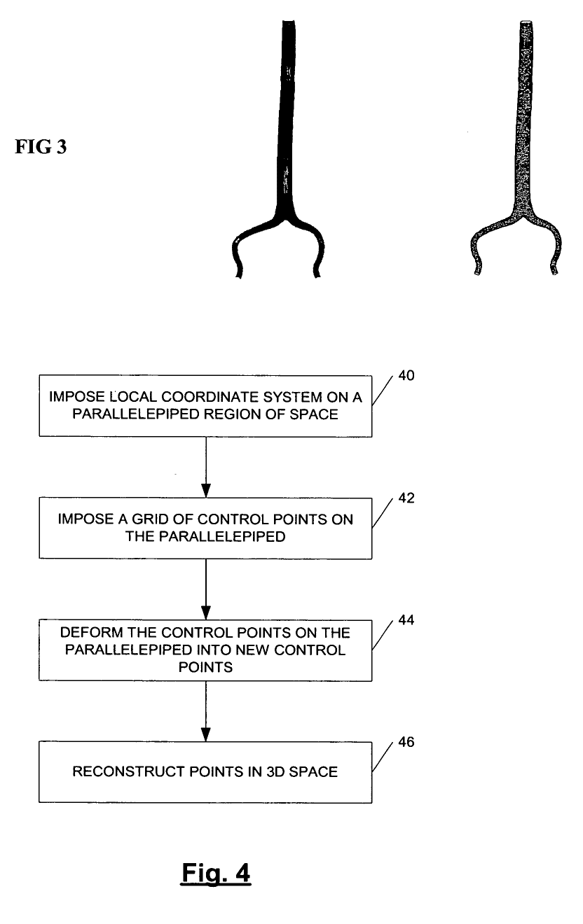

The deformation module 14 may proceed in the deformation process according to the process shown in the flowchart of FIG. 4. First, at step 40, a local coordinate system may be imposed on a 3D region of space by specifying any point Xin the following form:

$$X = {X}_{0} + sS + tT + uU$$

$$where \\ ( s , t , u ) = ( \frac{T ⨯ U \cdot ( X - {X}_{0} )}{T ⨯ U \cdot S} , \frac{S ⨯ U \cdot ( X - {X}_{0} )}{S ⨯ U \cdot T} , \frac{S ⨯ T \cdot ( X - {X}_{0} )}{S ⨯ T \cdot U} )$$

Note that for any interior point to the 3D space that 0≦s≦1, 0≦t≦1, and 0≦u≦1.

Next, at step 42, a grid of control points Pᵢⱼₖ is imposed on the 3D space. These form l+1 planes in the S direction, m+1 planes in the T direction, and n+1 planes in the U direction. These points lie on a lattice, and their locations are defined by:

$${P}_{ijk} = {X}_{0} + \frac{i}{l} S + \frac{j}{m} T + \frac{k}{n} U$$

Next, at step 44, the control points are deformed on the 3D space into new control points. Then, at step 46, any point in the three-dimensional space may be reconstructed by first calculating its (S, T, U) coordinates, and then inserting those coordinates into the trivariate Bevier function,

$${X}_{ffd} = {\sum }_{i = 0}^{l} {\sum }_{j = 0}^{m} {\sum }_{k = 0}^{n} {B}_{l}^{i} ( s ) {B}_{m}^{j} ( t ) {B}_{n}^{k} ( u ) {P}_{ijk}$$

with the Bernstein polynomials,

$${B}_{l}^{i} ( s ) = \frac{l !}{i ! ( l - i ) !} {{s}^{i} ( 1 - s )}^{l - i}$$

Thus, EEFD, in opposition to traditional FFD, uses the initial lattice points to define an arbitrary trivariate Bevier volume, and allows the combining of many lattices to form arbitrary shaped spaces.

Cylindrical lattices may be used, as shown in FIG. 5. Cylindrical lattices may be obtained by conjoining to opposite faces of a parallelepiped lattice and by merging all points of the cylindrical axis. Also, with a cylindrical lattice, it is reasonable to fit the area between CT scan contours and planar cross contours of the template because most of the contours of the CT scans are closed curved lines.

When using cylindrical lattices, a simple projection method may be used to calculate the (S, T, U) coordinates of the model points in a non-parallelepiped lattice. According to various embodiments of this process, t is computed as in conventional FFD processes, while the T axis is the cylindrical axis. The S axis may be defined as the radial coordinate and the U axis as the angular coordinate on the base plane of the cylinder. Next, u may be computed from the angle between a point projected on the SU plane and the S axis. Next, the line which connects the origin with the mid-point of the others in the triangle can be defined. The projected point on the SU plane is projected on the line again. Next, s may be obtained from the ratio between the entire line length and the length obtained by the projected point.

EEFD with an interpolation function having linear polynomials may be used as a unit deformation block and multiple deformations may be combined on CT scan images in the given order, as shown in FIG. 5. At that time, there may be one active control point per lattice which has one degree of freedom only in the radial direction because the aim is to find the deformation that minimizes the area between the contours of the input images 18 and the planar cross contour of the template.

In EFFDs, continuity is one of the most important problems to consider because of working with piecewise lattices. Especially, when the height of each lattice is so wide that it can cause each sub-model which is involved in piecewise lattices to deform in a discontinuous manner, continuity becomes even more important. The fact that the deformation with linear polynomials may be used as a unit deformation block means that each lattice is at least connected with C⁰ continuity because the common control points remain coincident, as shown in FIG. 5. It is preferable to maintain at least tangent continuity (C¹) between two lattices. To do so, the deformation with linear polynomials must be extended to higher order polynomials.

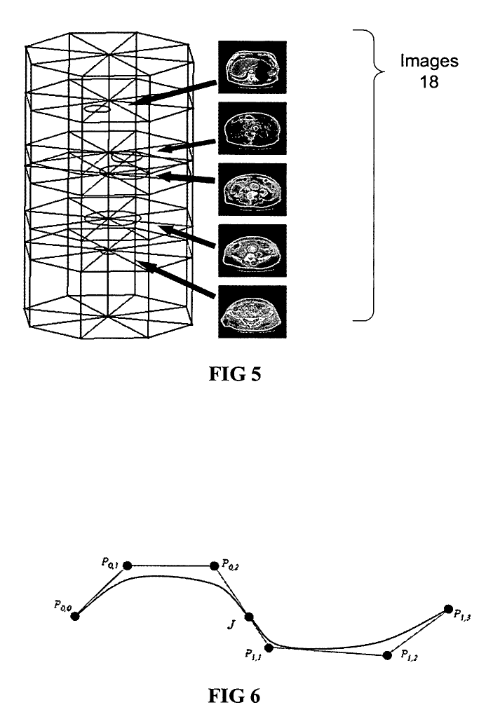

According to various embodiments, deformation with an interpolation function having cubic polynomials, that is, cubic Bezier curve in the vertical direction only, may be used to maintain C¹ continuity. In this situation, the problem is transferred to how to connect piecewise cubic Bezier curves to maintain C¹ continuity. Assuming that two cubic Bezier curves are just connected as shown in FIG. 6, C¹ continuity is achieved by making P_{0,2}, J, and P_{1,1} collinear. That means that the derivative vectors at the boundary are the same.

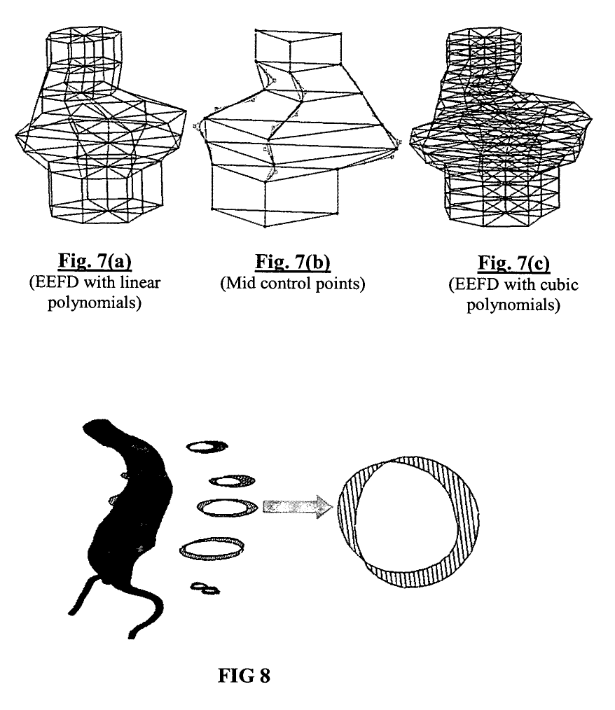

Natural cubic spline may be used to define mid control points to extend the deformation with linear polynomials to that with cubic polynomials. FIGS. 7(a)-(c) show how to find mid-control points by natural cubic spline. The points which lie on the angular direction are interpolated by natural cubic spline in vertical direction, respectively, as shown in FIG. 7(b). The interpolated spline curves can easily be expressed as cubic Bezier curves. Finally, the deformation with C⁰, C¹ continuity can be obtained.

The optimization module 16, as mentioned above, may use a non-linear optimization algorithm to find the optimal deformation of the template geometry to determine an optimal combination of free-form deformation parameters that generate a deformed 3D shape that matches the given input views 18. That is, the optimization module 16 may find control lattice parameters of EFFDs that minimize the area between the contours of the input images 18 and the planar cross contours of the template model. The objective function, or cost function, that may be used in the reconstruction process is the two-dimensional difference between the image contours and the planar cross contours of the template model. It may be computed by numerical approximation of the 2D error that needs to be minimized, as shown in FIG. 8. The two-dimensional bounding box that contains both an image contour and a planar cross contour of the template model may be created. This bounding box may then be discretized to shoot rays and intersect with the contours. The line segments shown in FIG. 8 are summed up to compute an approximate area difference between the image contours and the planar cross contours of the template model.

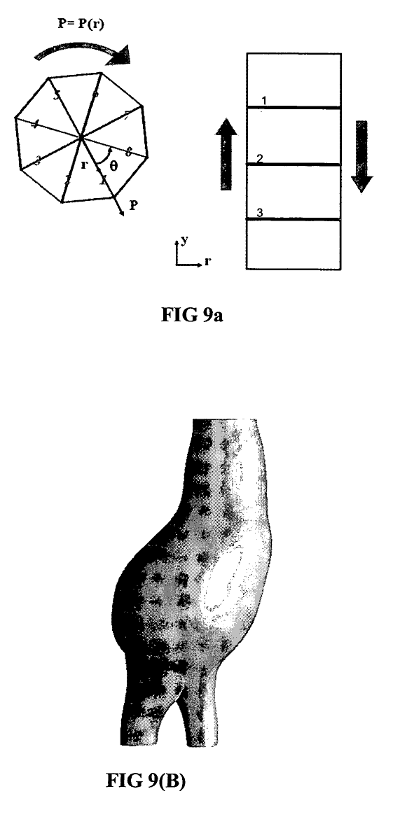

To solve this reconstruction problem effectively, a two-step optimization may be employed. In the first step, the main goal is to approximately match the center of the contour of the template with that of an image contour. At that time, the size of both contours is also fitted. All of control points which lie on an image move together to fit the center, and the size of the lattice increases or decrease constantly to fit the size. The result obtained in first step becomes a good initial condition for second step. In the second step, the main goal is to find the control lattice parameters that minimize the area between the scan contours and the planar cross contours of the template model. The number of optimization parameters may be proportional to the number of the lattices which lie on an image because the lattice has one degree of freedom only in the radial direction, as shown in FIG. 9(a). After the optimization problem for the one EFFD block is solved, the same process must be repeated proportional to the number of the lattices which lie on an image in the angular direction, and it is also repeated from the bottom block to the top block and from the top block to the bottom block. After the two-step optimization is finished, continuity control is adapted to the deformed lattices. The points which lie on the angular direction may be interpolated in vertical direction, respectively. Finally, the three-dimensional reconstruction geometry may be obtained by comparing between all CT scan contours and the contours of the deformed model, as shown in FIG. 9(b).

The following describes an embodiment of the 3DSRS 10 that was used to reconstruct a three-dimensional AAA based on input CT images. Generally, a three-dimensional geometric model of an aneurysm consists of the exterior and interior surfaces of the abdominal aorta. One is the external contour of the AAA, often called the “external wall,” and the other is the internal contour of the AAA or the lumen. The internal contour and the external contour of AAA may be extracted separately from the CT images.

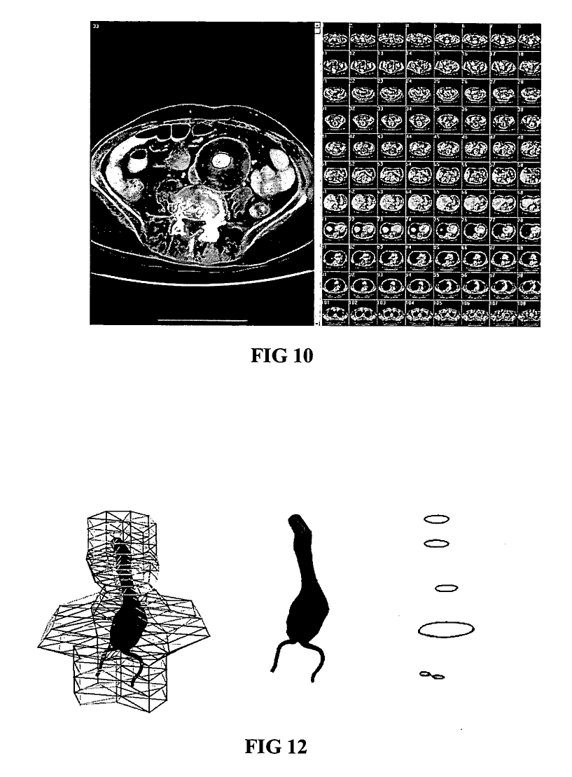

In this example, abdominal CT images with a 5 mm interval in the axial direction were used, and the CT scans were imported into image processing software (e.g., 3D Doctor v3.5, Able Software Corp., USA). The external and internal contours of the AAA were marked manually to give its (x-y) profile in 2D, which was output as a text file. The process was repeated for each slice of the AAA, as shown in FIG. 10. The z-coordinate of each slice was added subsequently using the slice thickness information.

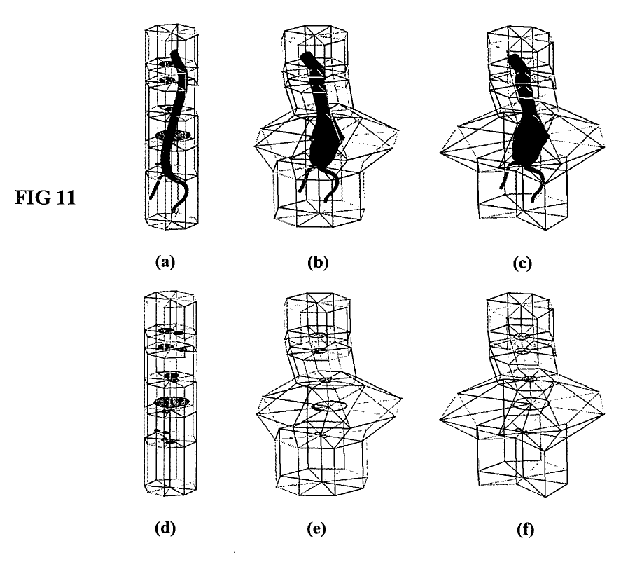

Five of the coutours (see FIG. 10) thus created were first selected to recontruct the external wall of AAA. FIGS. 11(a)-(f) illustrate the process for three-dimensional reconstruction by using EFFD. First, the initial position of the template model was calibrated to be applied to the CT scan contours and the size of the lattices was initialized. In this example, eight lattices with linear interpolation were utilized on a CT image, and the lattices were layered according to the location of CT images, as shown in FIGS. 11(a) and 11(d). Then, the first step of the optimization process was performed (see FIGS. 11(b) and 11(e)). The adjustment between the center of the contour of the template and that of a CT scan contour was performed by moving the origin of all lattices simultaneously. Also, the adjustment of the contour size generated by the template model was performed by handling the radius of all lattices on the CT image simultaneously. Therefore, the contour size increases or decreases constantly to fit that of the CT image. An error may still remain because the goal of this step is to match approximately the center and the size of the contour of the template with those of a CT scan contour. However, the control points obtained at this step are good starting points for the second step of the optimization process. Next, the second step of the optimization process was performed and the external wall of AAA was obtained. The error almost disappeared as shown in FIG. 11(f), but the reconstruction shape was unnatural because C¹ continuity between the lattices was not maintained. To maintain C¹ continuity, the deformation with linear polynomials was extended to that with cubic polynomials by using natural cubic spline. That means that the lattice with l=1, m=3, n=1 was substituted for the lattice with l=1, m=1, n=1, and the mid-control points were defined by natural cubic spline. FIG. 12 shows the wall of AAA obtained by EFFD with continuity control.

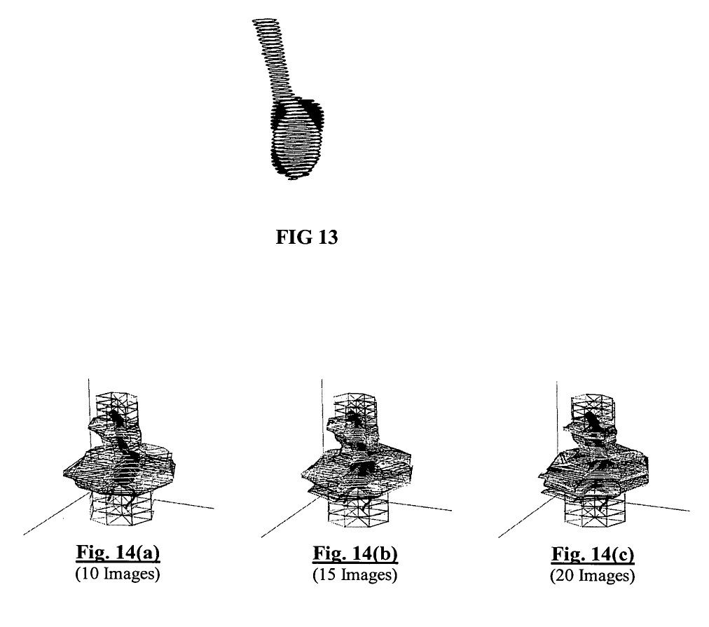

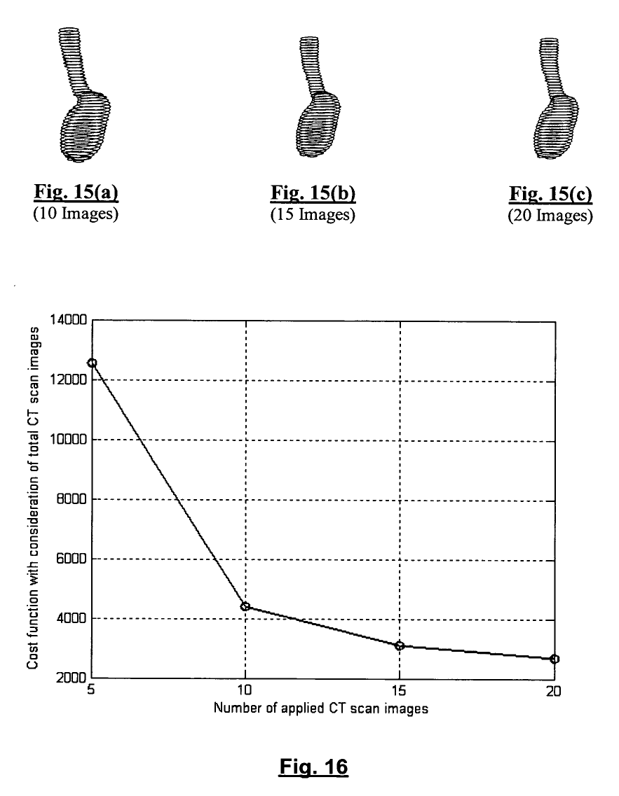

After the reconstruction model was obtained by EFFD with continuity control, the accuracy of the model was tested. To do so, it was compared with the entire CT images, as shown in FIG. 13. The result shows that the reconstruction model obtained by 5 CT images is not sufficient to express the actual wall of AAA. So, the number of CT images was increased to 10, 15 and 20. FIGS. 14(a)-(c), respectively, show the results obtained by EFFD with continuity control and they are compared with the entire CT images, as shown in FIGS. 15(a)-(c). FIG. 16 shows the effect of the number of CT images used for the three-dimensional reconstruction of the AAA. The more CT images were used, the more accurate the reconstruction model was. However, the appropriate reconstruction model for finite element analysis was already obtained when the number of CT images reached 15. Although the reconstruction model may be a little bit more accurate by using over 15 CT images, there is little improvement as a finite element model in this example.

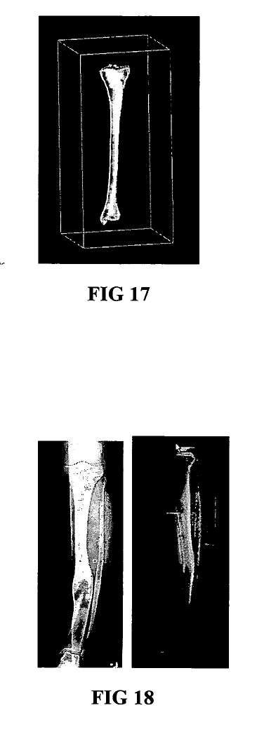

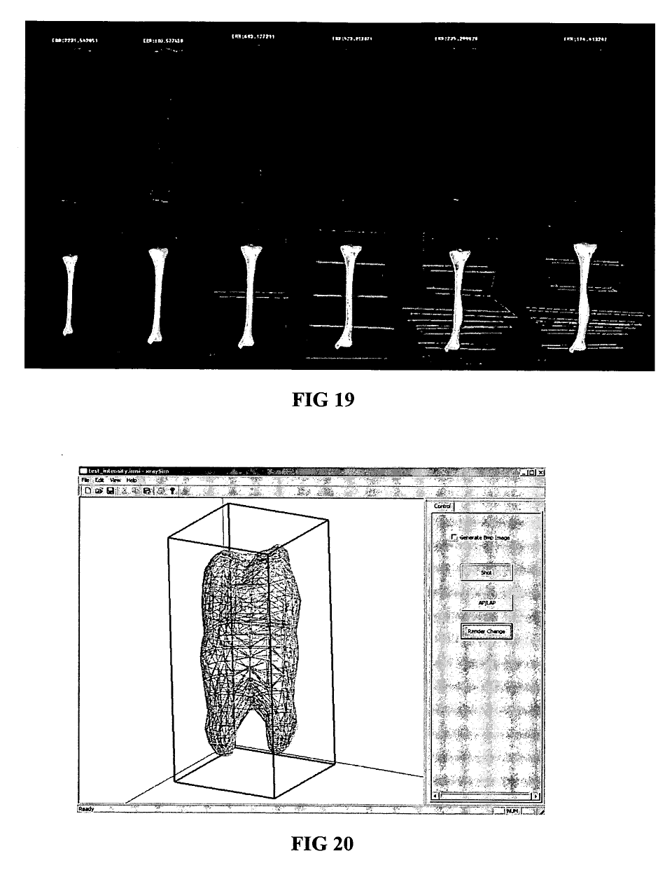

According to other embodiments, the 3DSRS 10 may be used, for example, to reconstruct bone geometries. In such applications, the 3DSRS 10 may use x-ray images of the bone, which may or may not be orthogonal images. FIG. 17 shows an exemplary template geometry for a human leg bone, the tibia. FIG. 18 shows two sample input images from which the 3D reconstruction is generated. In this case, the images are orthogonal x-ray images of the bone. FIG. 19 shows the process of generating the 3D geometry of the bone using the EEFD and optimization processes of the 3DSRS 10.

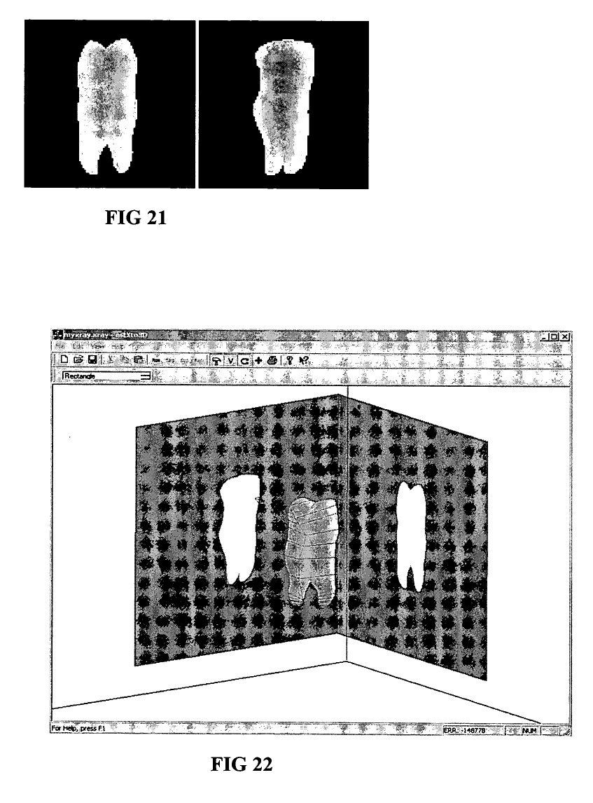

In another application, the 3DSRS 10 may be used to reconstruct the 3D geometry of a tooth (or teeth). An example of the template geometry for such an application is shown in FIG. 20. In this example, the input images are two orthogonal x-ray images of the tooth, shown in FIG. 21. FIG. 22 shows the 3D geometry generated from the input images in this example.

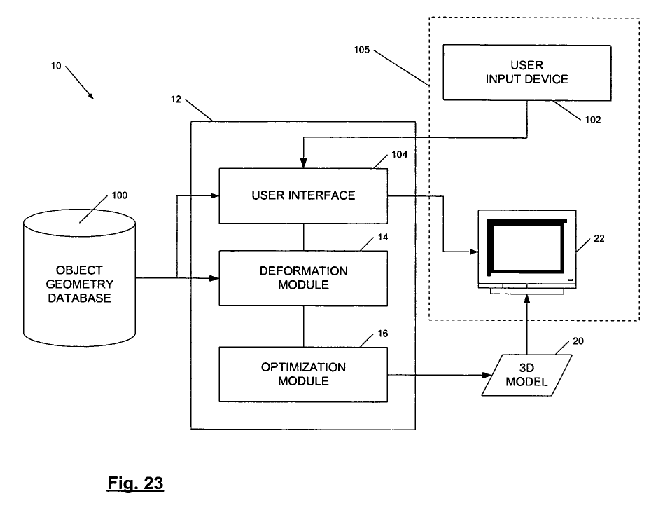

According to another embodiment, the 3DSRS 10 may be used to provide an interactive design tool for objects. An embodiment of the 3DSRS 10 for such an application is shown in FIG. 23. 3D geometry data for the objects subject to the design application may be stored in a geometry database 100. In the discussion to follow, the object to be designed is an automobile, but it should be recognized that the design tool could be used for other types of object, such as airplanes, trucks, characters for movies, etc. The user, via a user interface program 104, is displayed a diagram of the object to be designed based on the geometry data in the database 100 on a monitor 22 of a graphical user interface 105. Through a user-input device 102 of the graphical user interface 105, such as a mouse, a stylus for a tablet PC, etc., the user may first indicate a portion of the object to be modified and then indicate the target geometry for the modified design. The user interface program 104 may read these inputs and input them to the deformation module 14. The deformation module 14 and optimization module 16 may generate a modified 3D geometry for the object based on the indicated target geometry for the object specified by the user according to EEFD and optimization processes described above. The modified object geometry may then be displayed for the user on the monitor 22. In this way, the user/designer may be provided an intuitive means for modifying an existing design of an object (such as a car). Using the system 10, a designer can modify an object design in an intuitive fashion using a sketch-based user-interface. The deformation may occur within a fraction of a second, providing the designer with a highly interactive and intuitive design environment.

The geometries for the geometry database 100 may be, for example, commercial available object geometry data, or they may be scanned mesh geometry data from models of the object.

For such an application, the 3DSRS 10 may use hierarchical EFFD to scale and deform the initial or existing design, and a deformation in each free-form deformation layer is controlled by eight variables. The problem of finding a new three-dimensional shape of the existing design is thus reduced to an optimization problem with eight design variables. The optimization module 16 minimizes the error, or the difference between a curve on the initial shape (e.g., existing design) and a target curve that depicts the designer's intention on a desired geometric modification (the “modified design”). Sequential quadratic programming (SQP) may be used to solve this multi-dimensional optimization problem.

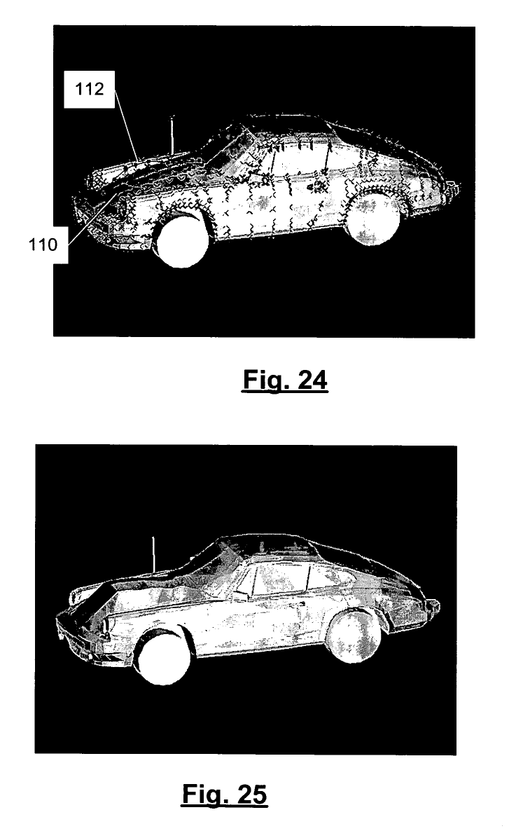

FIGS. 24 and 25 provide an overview of how the design system may operate in designing an automobile. FIG. 24 is an example of the existing automobile design that may be displayed for the user. The user may draw a first line 110 on the existing design with the user input device 102 indicating the area of the object to be modified and a second line 112 indicating the target geometry. FIG. 25 is an example of the modified design based on the target geometry input by the user in FIG. 24.

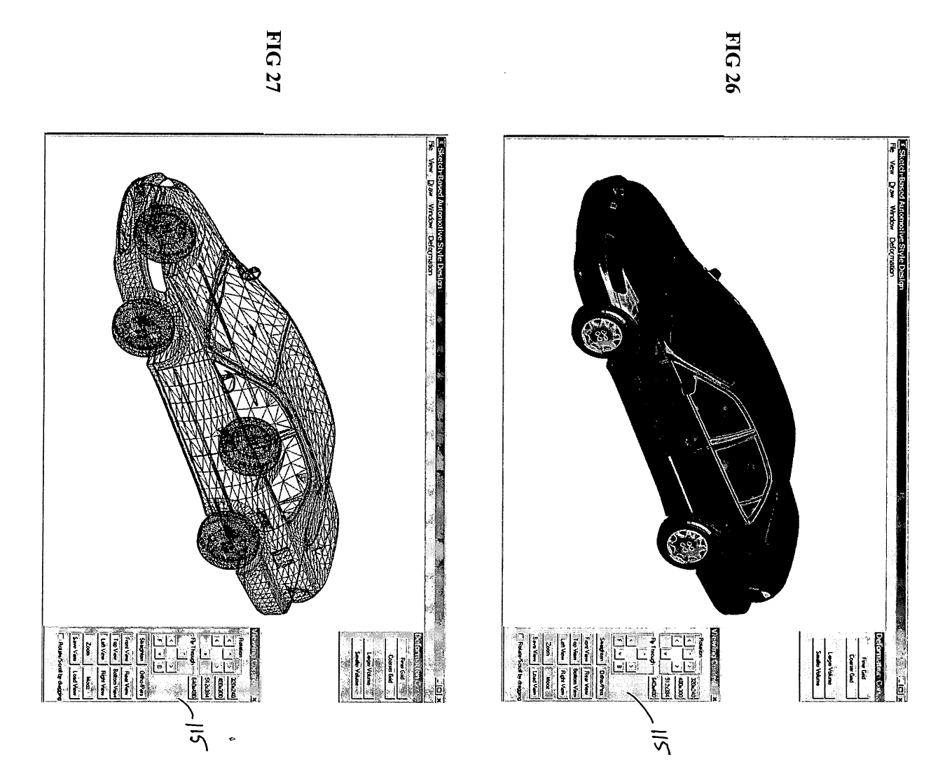

FIGS. 26-31 provide more details for an embodiment of the 3DSRS 10 used to modify existing designs for automobiles. FIGS. 26 and 27 show displays that may be generated by the user interface program 104. FIG. 26 is a 3D picture of the existing automobile design, based on the data in the database 100, and FIG. 27 is diagram of the 3D polygonal mesh of the existing automobile design. The use may toggle between the views using the “View” command in the toolbar. Also, the user may control the vantage point of the view using the “Viewing Control” tool bar 115.

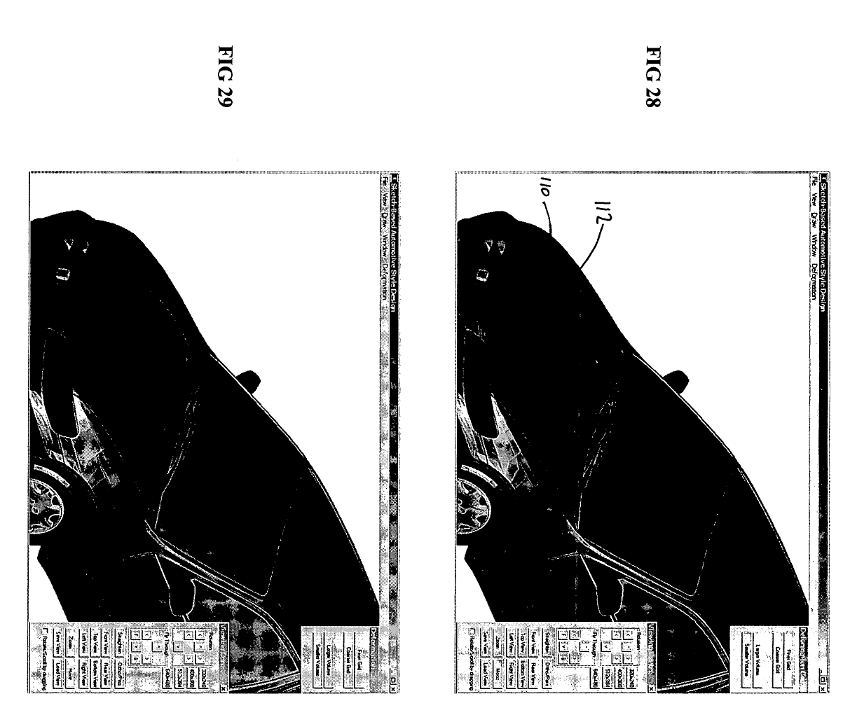

FIG. 28 shows two lines drawn on the automobile to generate the modified design. The line 110 shows the area of the design to be modified and the line 112 shows the intended target geometry (i.e., the modified design). FIG. 29 shows the 3D geometry of the car based on the target geometry as determined by the EEFD and optimization processes performed by the 3DSRS 10. As can be seen in FIG. 29, the front hood of the car is somewhat rounded, or bulged, with the modified design.

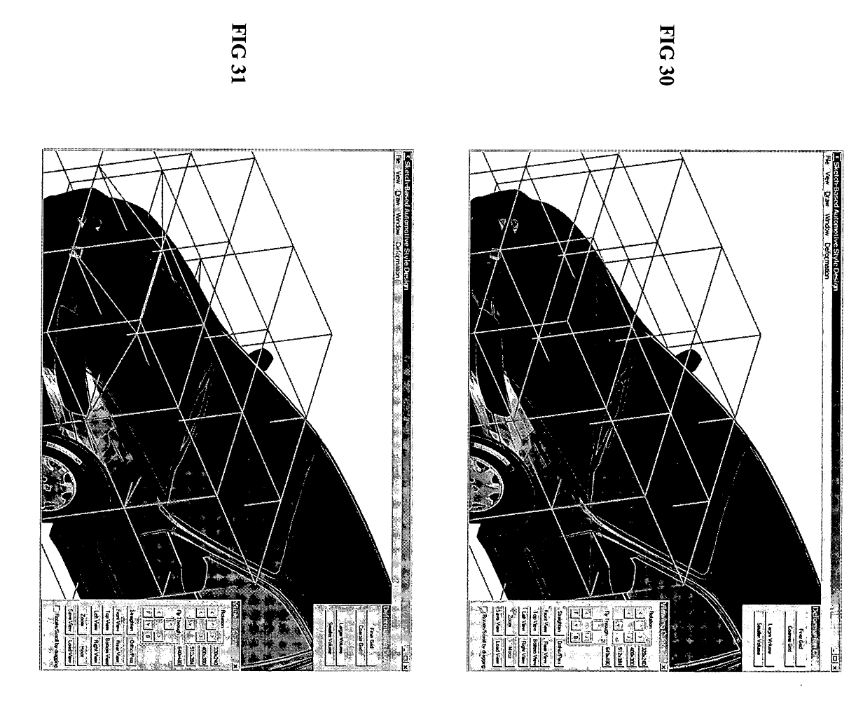

As shown in FIGS. 30 and 31, the user may also choose to see the free-form deformation grids used to deform the object by using, for example, an option under the “View” command of the toolbar. FIG. 30 shows the free-form deformation grid prior to deformation and FIG. 31 shows the free-form deformation grid after the deformation process.

While several embodiments of the invention have been described, it should be apparent, however, that various modifications, alterations and adaptations to those embodiments may occur to persons skilled in the art with the attainment of some or all of the advantages of the present invention. For example, various steps of the processes described herein may be performed in separate orders. Also, the user displays shown herein are intended to be illustrative and not limiting.

What is claimed is:

1. A system for generating a three-dimensional model of an object comprising:
a deformation module for applying an extended free form deformation on an input set of CT scans of the object using a template geometry for the geometry of the object; and
an optimization module for determining a combination of free-form deformation parameters corresponding to a deformed three-dimensional shape that optimally matches the input set of CT scans of the object.

2. The system of claim 1, wherein the template geometry includes non-rectangular grids.

3. The system of claim 2, wherein the template geometry includes triangular grids.

4. The system of claim 2, wherein the template geometry includes hexagonal grids.

5. The system of claim 1, wherein the deformation module uses a polynomial interpolation function.

6. The system of claim 5, wherein the deformation module uses a linear polynomial interpolation function.

7. The system of claim 5, wherein the deformation module uses a higher-order polynomial interpolation function.

8. The system of claim 7, wherein the higher-order polynomial interpolation function includes a cubic Bezier curve.

9. The system of claim 7, wherein the deformation module uses a non-polynomial interpolation function.

10. The system of claim 1, wherein the optimization module uses a non-linear optimization algorithm.

11. The system of claim 1, wherein the optimization module is for determining the combination of free-form deformation parameters corresponding to the deformed three-dimensional shape that optimally matches the input set of CT scans of the object by:
matching a center of a contour of the template geometry with a center of a contour in the input set of CT scans; and
determining control lattice parameters that minimize the area between the contours of the input set of CT scans and planar cross contours of the template geometry.

12. A system for generating a three-dimensional model of an object comprising:
a deformation module for applying an extended free form deformation to a template geometry for the object based on an input set of images of the object, wherein a deformation lattice of the template geometry includes non-rectangular grids; and
an optimization module for determining a combination of free-form deformation parameters corresponding to a deformed three-dimensional shape that optimally matches the input set of CT scans of the object.

13. A system for designing an object, comprising:
a graphical user interface including a user input device for inputting a design modification to an existing design of the object displayed for the user on the graphical user interface;
a three-dimensional shape reconstruction system in communication with the graphical user interface for generating a three-dimensional model of the object based on the design modification input by the user.

14. The system of claim 13, wherein the design modification includes an input to indicate a desired geometry for a portion of the existing design.

15. The system of claim 14, wherein the three-dimensional shape reconstruction system includes:
a deformation module for applying an extended free form deformation on a template geometry for the existing design; and
an optimization module for determining a combination of free-form deformation parameters corresponding to a deformed three-dimensional shape that optimally matches the design modification.

16. The system of claim 15, wherein the template geometry includes non-rectangular grids.

17. The system of claim 16, wherein the template geometry includes triangular grids.

18. The system of claim 16, wherein the template geometry includes hexagonal grids.

19. The system of claim 15, wherein the deformation module uses a polynomial interpolation function.

20. The system of claim 15, wherein the deformation module uses a linear polynomial interpolation function.

21. The system of claim 15, wherein the deformation module uses a cubic polynomial interpolation function.

22. The system of claim 21, wherein the deformation module uses a non-polynomial as the interpolation function.

23. The system of claim 15, wherein the optimization module uses a non-linear optimization algorithm.

24. The system of claim 15, wherein the optimization module uses a linear optimization algorithm.

25. The system of claim 15, wherein the optimization module is for determining the combination of free-form deformation parameters corresponding to the deformed three-dimensional shape that optimally matches the design modification by:
matching a center of a contour of the template geometry with a center of a contour in the design modification; and
determining control lattice parameters that minimize the area between the contours of the design modification and planar cross contours of the template geometry of the existing design.

26. A method for generating a three-dimensional model of an object comprising:
applying an extended free form deformation on an input set of CT scans of the object using a template geometry for the geometry of the object; and
determining a combination of free-form deformation parameters corresponding to a deformed three-dimensional shape that optimally matches the input set of CT scans of the object.

27. A method for generating a three-dimensional model of an object comprising:
applying an extended free form deformation to a template geometry for the object based on an input set of images of the object, wherein the template geometry includes non-rectangular grids; and
determining a combination of free-form deformation parameters corresponding to a deformed three-dimensional shape that optimally matches the input set of CT scans of the object.

28. A method for designing an object, comprising:
displaying an existing three-dimensional design of the object on a graphical user interface;
receiving, from a user of the graphical user interface, a design modification to the existing design;
generating a three-dimensional model of the object based on the design modification by:
applying an extended free form deformation on a template geometry for the existing design; and
determining a combination of free-form deformation parameters corresponding to a deformed three-dimensional shape that optimally matches the design modification.
